(19) United States
(12) Patent Application Publication
(10) Pub. No.: US 2012/0092321 A1
(43) Pub. Date: Apr. 19, 2012

(54) LIQUID CRYSTAL DISPLAY

(75) Inventors: YEN-FEN LIN, Luzhu Township (TW); Yi-cheng Tsai, Pingzhen City (TW)

(73) Assignee: CHUNGHWA PICTURE TUBES, LTD., Bade City (TW)

(21) Appl. No.: 13/029,104

(22) Filed: Feb. 16, 2011

(30) Foreign Application Priority Data
Oct. 15, 2010 (TW) 099135330

(51) Int. Cl. G09G 3/36; G06F 3/038

(52) U.S. Cl. 345/211; 345/90

(57) ABSTRACT

An LCD includes a first pixel electrode coupled to a first scan line and a data line, and a second pixel electrode coupled to a second scan line and the data line. A first and a second storage capacitor electrode lines are at two sides of the data line and across the scan lines. A first storage capacitor electrode extension line is extended out of the first storage capacitor electrode line and toward the data line, and a second storage capacitor electrode extension line is extended out of the second storage capacitor electrode line and toward the data line. The first pixel electrode and second pixel electrode partly overlap the first and the second storage capacitor electrode extension lines, respectively. Since the storage capacitor electrode line and the scan line is formed on different metal layer, a gap between the storage capacitor electrode line and the scan line is shortened.

### RELATED APPLICATIONS

This application claims priority to Taiwan Patent Application Serial Number 099135330, filed on Oct. 15, 2010, which is herein incorporated by reference.

### BACKGROUND OF THE INVENTION

1. Field of the Invention

The present invention relates to a liquid crystal display (LCD), and more particularly, to an LCD capable of improving its aperture ratio.

2. Description of Prior Art

An advanced monitor with multiple functions is an important feature for use in current consumer electronic products. Liquid crystal displays (LCDs) which are colorful monitors with high resolution are widely used in various electronic products such as monitors for mobile phones, personal digital assistants (PDAs), digital cameras, laptop computers, and notebook computers.

An LCD comprises two substrates having electrodes and a liquid crystal (LC) layer between the two substrates. Voltage is applied on the electrodes so the LC molecules inside the LC layer are reoriented to control light transmission. The electrodes can be formed on either one of the two substrates. One of the substrates comprises a thin film transistor (TFT) array panel thereon and the other substrate comprises a color filter thereon. A TFT array panel comprises a plurality of scan lines, a plurality of data lines crossing over the plurality of scan lines and defining multiple pixel regions, multiple TFTs each of which is formed on each of the pixel regions and is electrically connected to one of the gates and one of the data lines, and pixel electrodes electrically connected to the TFTs. Storage capacitors are formed on the TFT array panel so that voltage can be unchangeably applied on the LC molecules between the two substrates. For this object, a metal line of the storage capacitor and the scan lines are formed by the same metal layer so that the metal layer can overlap with the pixel electrode to form the storage capacitor.

Please refer to FIG. 1, which shows a part of a conventional TFT array panel 10. The TFT array panel 10 adopts a design concept of using a dual gate line. A gate driver (not shown) outputs a scan signal via a scan line 22, causing transistors 28 in each row to be turned on in turn. Meanwhile, a source driver (not shown) outputs a corresponding data signal to pixel electrodes 24 arranged in a row via data lines 20. The pixel electrodes 24 are charged individually to the required voltages to display different gray levels. When the pixel electrodes 24 arranged in the same row finish charging, the gate driver turns off the scan signal applied on the scan line corresponding to the row. Then, the gate driver outputs the scan signal again to conduct the transistors 28 in the next row, and the source driver outputs data signal to charge the pixel electrodes 24 in the next row. According to this sequence, all of the pixel electrodes 24 on the TFT array panel 10 will complete being charged. Afterwards, the pixel electrodes 24 on the first row are charged once again and all the pixel electrodes 24 repeat the above-mentioned mechanism. A storage capacitor electrode line 26 is displaced on a place corresponding to the pixel electrode 24 to form a storage capacitor so that the pixel electrode 24 can display gray levels based on the data signal even though no scan signal drives the transistors 28. The storage capacitor stores the data signal to maintain constant voltage applied on the pixel electrode 24 until the pixel electrode 24 begins to be charged at the next scan.

However, although the storage capacitor electrode line 26 and the scan line 22 are used for delivering different signals, they actually are made by the same metal layer. Therefore, signal coupling effects and the limit of manufacturing precision need to be taken into considerations in circuit layouts. That's why the gap d1 between the storage capacitor electrode line 26 and the scan line 22 has to be reserved. The larger the gap d1 is, the smaller the aperture ratio of a pixel and the smaller the transmission ratio become, further increasing the cost of the conventional TFT array panel 10.

### SUMMARY OF THE INVENTION

Therefore, the main object of the present invention is to provide an LCD capable of improving its aperture ratio to solve problems occurring in the prior art. The present invention can not only overcome the limit of manufacturing precision but also increase brightness as well as reduce manufacturing costs.

According to the present invention, a liquid crystal display comprises a first pixel electrode, a second pixel electrode, a first scan line, a second scan line, a data line, a first storage capacitor electrode line and a second storage capacitor electrode line. The first scan line is electrically connected to the first pixel electrode. The second scan line is electrically connected to the second pixel electrode. The data line is electrically connected to the first pixel electrode and the second pixel electrode. The first storage capacitor electrode line and the second storage capacitor electrode line are formed at both sides of the data line and crossing over the first scan line and the second scan line. The first storage capacitor electrode line further comprises a first storage capacitor electrode extension line extending toward the data line from the first storage capacitor electrode line. The second storage capacitor electrode line further comprises a second storage capacitor electrode extension line extending toward the data line from the second storage capacitor electrode line. An edge of the first pixel electrode partially overlaps with the first storage capacitor electrode line and with the first storage capacitor electrode extension line, and an edge of the second pixel electrode partially overlaps with the second storage capacitor electrode line and with the second storage capacitor electrode extension line.

In one aspect of the present invention, the first storage capacitor electrode line, the second storage capacitor electrode line, the first storage capacitor electrode extension line, the second storage capacitor electrode extension line, and the data line are made of the same material.

In another aspect of the present invention, the liquid crystal display further comprises a connection region electrically connected to the first storage capacitor electrode extension line and to the second storage capacitor electrode extension line.

In another aspect of the present invention, the liquid crystal display further comprises a third pixel electrode, a fourth pixel electrode, a third scan line, and a fourth scan line. The third scan line is electrically connected to the third pixel electrode and the fourth scan line is electrically connected to the fourth pixel electrode. The third pixel electrode is electrically connected to the data line and to the first storage capacitor electrode line, and the fourth pixel electrode is electrically connected to the data line and to the second storage capacitor electrode line. The edge of the third pixel electrode partially overlaps with the first storage capacitor electrode line and the third storage capacitor electrode extension line, and the edge of the fourth pixel electrode partially overlaps with the second storage capacitor electrode line and the fourth storage capacitor electrode extension line.

In another aspect of the present invention, the first storage capacitor electrode line further comprises a third storage capacitor electrode extension line extending toward the data line from the first storage capacitor electrode line, and the second storage capacitor electrode line further comprises a fourth storage capacitor electrode extension line extending toward the data line from the second storage capacitor electrode line.

In another aspect of the present invention, the first storage capacitor electrode extension line is close to and parallel to the second scan line, and the second storage capacitor electrode extension line is close to and parallel to the first scan line. The liquid crystal display further comprises a connection line electrically connected to the first storage capacitor electrode extension line and to the fourth storage capacitor extension line electrode.

In another aspect of the present invention, the first storage capacitor electrode extension line is close to and parallel to the first scan line, and the second storage capacitor electrode extension line is close to and parallel to the second scan line. The liquid crystal display further comprises a connection line electrically connected to the second storage capacitor electrode extension line and to the third storage capacitor electrode extension line.

These and other objects of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a part of a conventional TFT array panel.

FIG. 2 is a layout of a TFT array panel according to a first embodiment of the present invention.

FIG. 3 is a layout of a TFT array panel according to a second embodiment of the present invention.

FIG. 4 is a layout of a TFT array panel according to a third embodiment of the present invention.

FIG. 5 is a layout of a TFT array panel according to a fourth embodiment of the present invention.

FIG. 6 is a layout of a TFT array panel according to a fifth embodiment of the present invention.

FIG. 7 is a layout of a TFT array panel according to a sixth embodiment of the present invention.

### DETAILED DESCRIPTION OF THE PREFERRED EMBODIMENTS

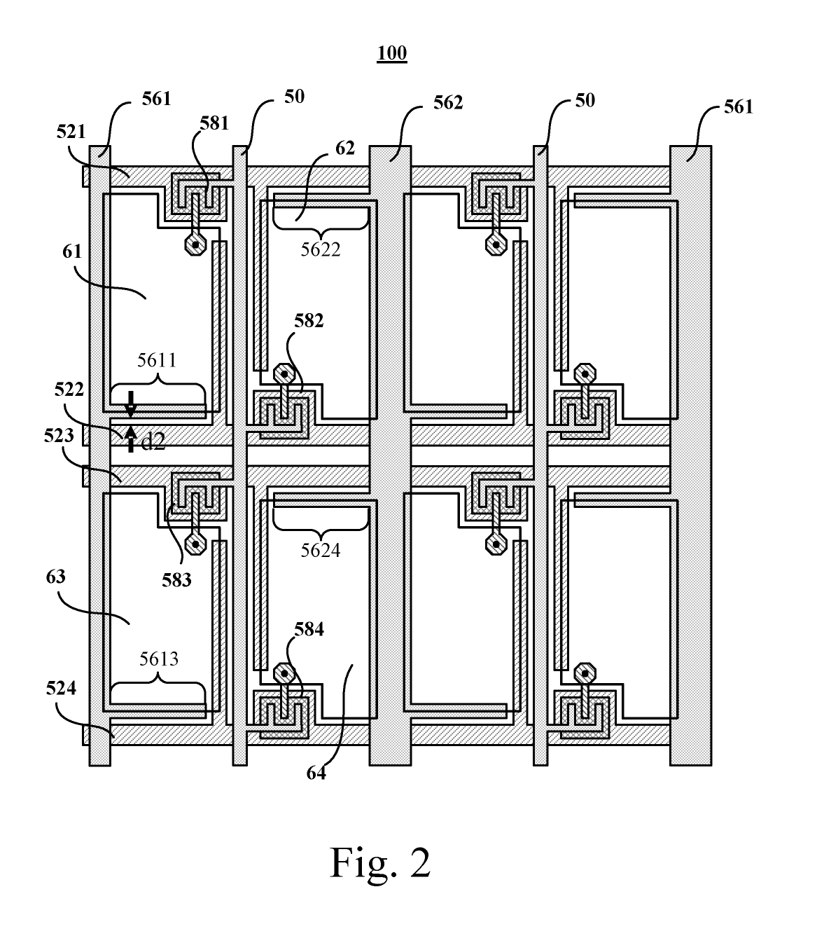

Refer to FIG. 2, which is a layout of a TFT array panel 100 according to a first embodiment of the present invention. The TFT array panel 100 used in an LCD comprises a first pixel electrode 61, a second pixel electrode 62, a third pixel electrode 63, a fourth pixel electrode 64, a first scan line 521, a second scan line 522, a third scan line 523, a fourth scan line 524, a data line 50, transistors 581-584, a first storage capacitor electrode line 561, and a second storage capacitor electrode line 562.

The first pixel electrode 61 is electrically connected to the first scan line 521 and the data line 50 via the transistor 581. The second pixel electrode 62 is electrically connected to the second scan line 522 and the data line 50 via the transistor 582. The third pixel electrode 63 is electrically connected to the third scan line 523 and the data line 50 via the transistor 583. The fourth pixel electrode 64 is electrically connected to the fourth scan line 524 and the data line 50 via the transistor 584. The first storage capacitor electrode line 561 and the second storage capacitor electrode line 562 are disposed at both sides of the data line 50 and cross over the third scan line 523 and the fourth scan line 524. The first pixel electrode 61 and the third pixel electrode 63 partially overlap with the first storage capacitor electrode line 561. The second pixel electrode 62 and the fourth pixel electrode 64 partially overlap with the second storage capacitor electrode line 562. The first storage capacitor electrode line 561, the second storage capacitor electrode line 562, and the data line 50 all made of the same material are disposed on the same plane. The first storage capacitor electrode line 561 and the second storage capacitor electrode line 562 are alternatively arranged with the data line 50.

The first storage capacitor electrode line 561 further comprises a first storage capacitor electrode extension line 5611 extended toward the data line 50 from the first storage capacitor electrode line 561. The second storage capacitor electrode line 562 further comprises a second storage capacitor electrode extension line 5622 extended toward the data line 50 from the second storage capacitor electrode line 562. The first storage capacitor electrode line 561 further comprises a third storage capacitor electrode extension line 5613 extended toward the data line 50 from the first storage capacitor electrode line 561. The second storage capacitor electrode line 562 further comprises a fourth storage capacitor electrode extension line 5624 extended toward the data line 50 from the second storage capacitor electrode line 562. According to the present embodiment, the extension line 5611 is close to and parallel to the second scan line 522. The extension line 5622 is close to and parallel to the first scan line 521. The extension line 5613 is close to and parallel to the fourth scan line 524. The extension line 5624 is close to and parallel to the third scan line 523.

The transistor 581 turns on in response to a scan signal transmitted from the first scan line 521 to transmit a data signal from the data line 50 to the first pixel electrode 61. A voltage difference between a pixel voltage received by the first pixel electrode 61 and a common electrode (not shown) of a conducting glass substrate induces an electric field. The electric field drives liquid crystal molecules between the conducting glass substrate and the first pixel electrode 61 to rotate. The transistor 582 turns on in response to a scan signal transmitted from the second scan line 522 to deliver a data signal from the data line 50 to the second pixel electrode 62. A voltage difference between a pixel voltage received by the second pixel electrode 62 and the common electrode of the conducting glass substrate generates an electric field. The electric field drives liquid crystal molecules between the conducting glass substrate and the second pixel electrode 62 to rotate. The transistor 583 turns on in response to a scan signal transmitted from the third scan line 523 to deliver a data signal from the data line 50 to the third pixel electrode 63. A voltage difference between a pixel voltage received by the third pixel electrode 63 and the common electrode of the conducting glass substrate generates an electric field. The electric field drives liquid crystal molecules between the conducting glass substrate and the third pixel electrode 63 to rotate. The transistor 584 turns on in response to a scan signal transmitted from the fourth scan line 524 to deliver a data signal from the data line 50 to the fourth pixel electrode 64. A voltage difference between a pixel voltage received by the fourth pixel electrode 64 and the common electrode of the conducting glass substrate generates an electric field. The electric field drives liquid crystal molecules between the conducting glass substrate and the fourth pixel electrode 64 to rotate.

To let the first pixel electrode 61 display gray levels based upon the data signal even though the scan signal does not drive the transistor 581, an overlap of the first pixel electrode 61 and the first storage capacitor electrode line 561 (including the extension line 5611) forms a storage capacitor for storing the data signal. Thus, the first pixel electrode 61 can still maintain the voltage for the data signal until the first pixel electrode 61 begins to be charged at the next scan. An overlap of the second pixel electrode 62 and the second storage capacitor electrode line 562 (including the extension line 5622) forms a storage capacitor for storing the data signal. Thus, the second pixel electrode 62 can still maintain the voltage for fixing the data signal until the second pixel electrode 62 begins to be charged at the next scan. An overlap of the third pixel electrode 63 and the first storage capacitor electrode line 561 (including the extension line 5613) becomes a storage capacitor for storing the data signal. Thus, the third pixel electrode 63 can still maintain voltage for fixing the data signal until the third pixel electrode 63 begins to be charged at the next scan. An overlap of the fourth pixel electrode 64 and the second storage capacitor electrode line 562 (including the extension line 5624) forms a storage capacitor for storing the data signal. Thus, the fourth pixel electrode 64 can still maintain the voltage for fixing the data signal until the fourth pixel electrode 64 begins to be charged at the next scan.

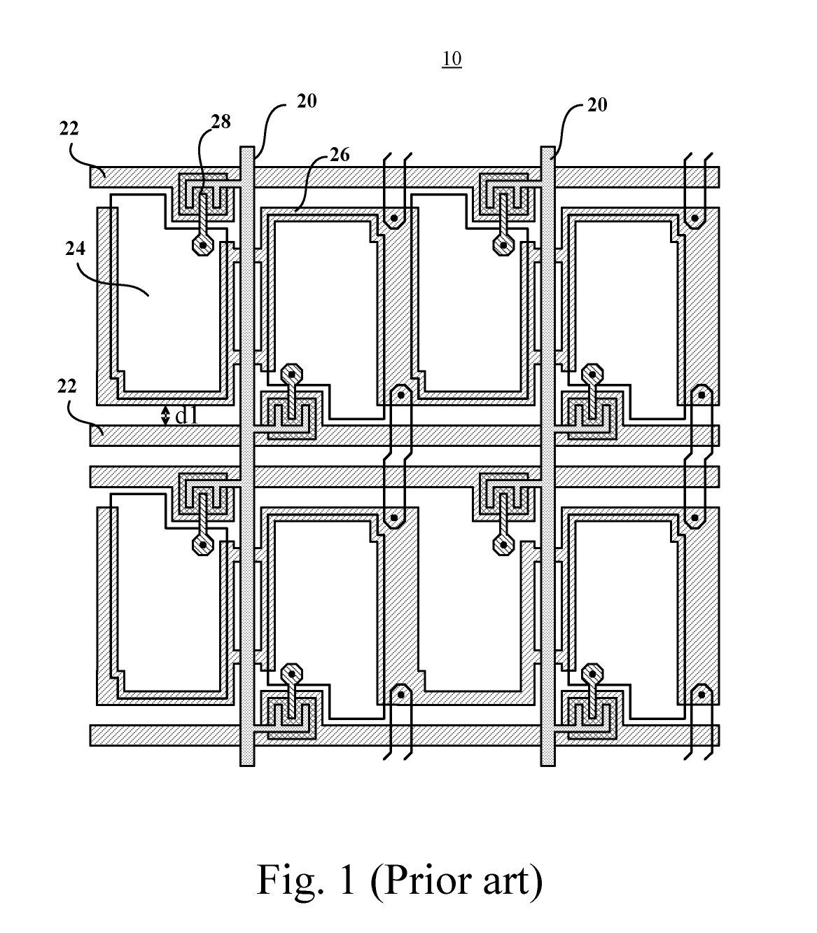

The storage capacitor electrode lines 561-562 and the scan lines 521-524 neither use the same metal layer nor form on the same plane. So no capacitive coupling effect will occur no matter how close the scan lines 521-524 and the storage capacitor electrode lines 561-562 are. Owing to almost no capacitive coupling effect between the scan lines 521-524 and on the storage capacitor electrode lines 561-562, it is allowed for a gap d2 between the storage capacitor electrode lines 561-562 and the scan lines 521-524 (e.g., between the extension line 5611 and the second scan line 522) to be smaller (compared with the gap d1 shown in FIG. 1), or even to be zero. Accordingly, the area of each of the pixel electrodes 61-64 can be larger, i.e., a larger aperture ratio. Therefore, the cost of the TFT array panel 100 can be reduced, and the efficiency of the TFT array panel 100 can be enhanced.

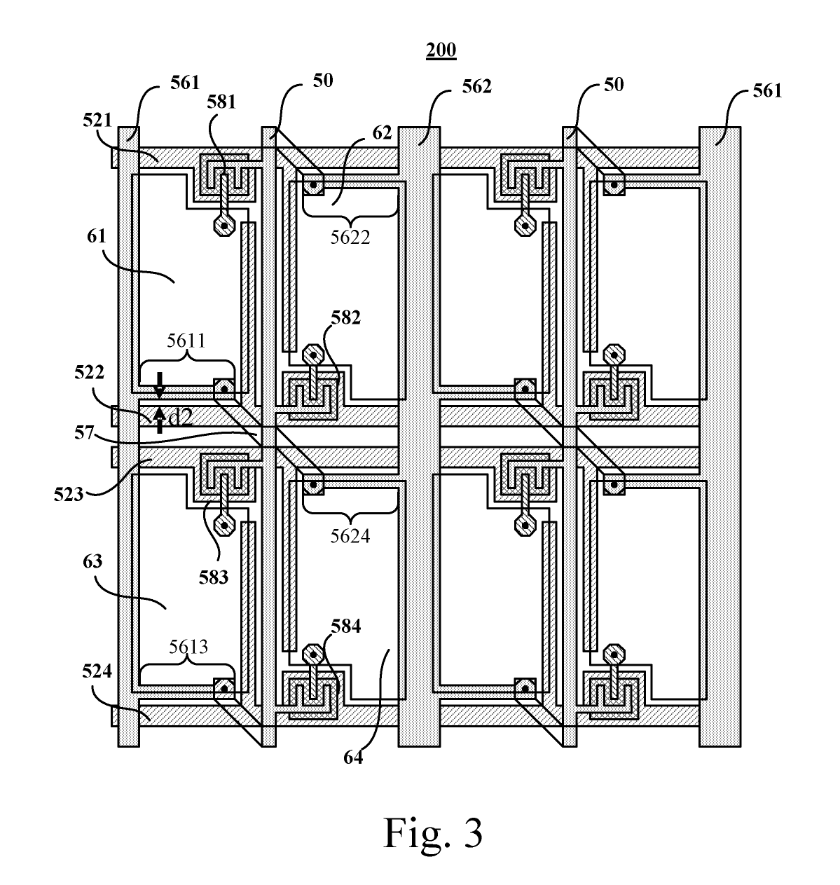

Refer to FIG. 3, which shows a layout of a TFT array panel 200 according to a second embodiment of the present invention. Differing from the TFT array panel 100, the TFT array panel 200 has a connection line 57 between the extension line 5611 and the extension line 5624. Owing to the connection line 57, the storage capacitor electrode lines 561 and 562 are less influenced by capacitive coupling effects caused by other signals, which solves a crosstalk problem and further improves display quality of the TFT array panel 200.

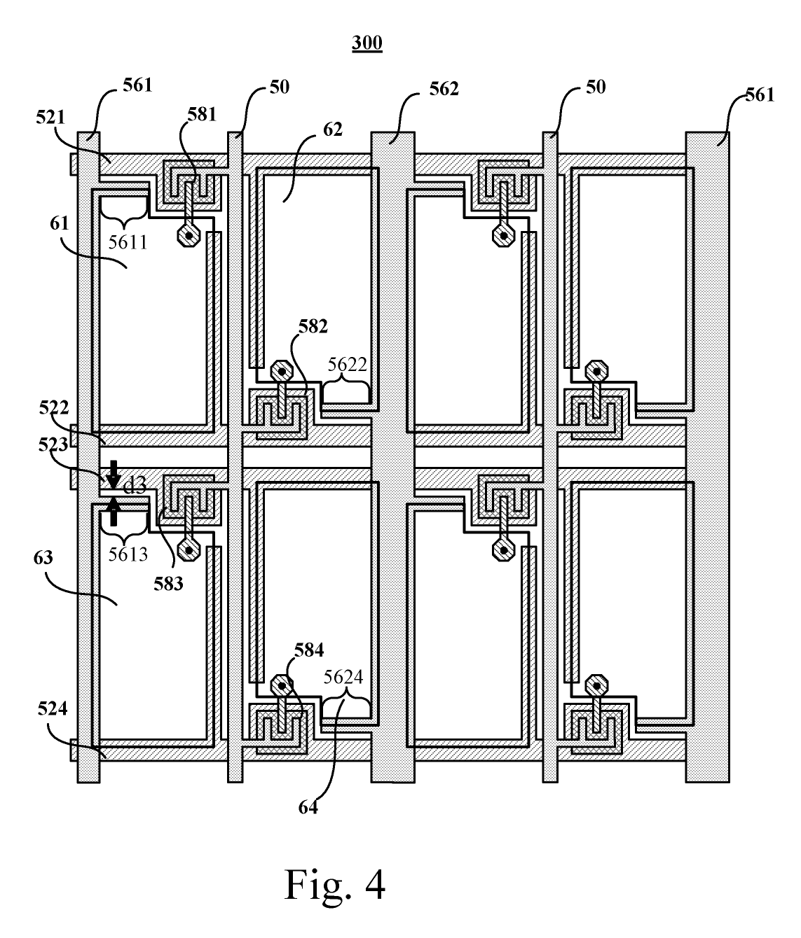

Please refer to FIG. 4 showing a layout of a TFT array panel 300 according to a third embodiment of the present invention. A first storage capacitor electrode line 561 of the TFT array panel 300 further comprises a first storage capacitor electrode extension line 5611 extended toward the data line 50 from the first storage capacitor electrode line 561. The second storage capacitor electrode line 562 further comprises a second storage capacitor electrode extension line 5622 extended toward the data line 50 from the second storage capacitor electrode line 562. The first storage capacitor electrode line 561 further comprises a third storage capacitor electrode extension line 5613 extended toward the data line 50 from the first storage capacitor electrode line 561. The second storage capacitor electrode line 562 further comprises a fourth storage capacitor electrode extension line 5624 extended toward the data line 50 from the second storage capacitor electrode line 562. According to the present embodiment, the extension line 5611 is close to and parallel to the first scan line 521. The extension line 5622 is close to and parallel to the second scan line 522. The extension line 5613 is close to and parallel to the third scan line 523. The extension line 5624 is close to and parallel to the fourth scan line 524.

To let the first pixel electrode 61 display gray levels based upon the data signal even though the scan signal does not drive the transistor 581, the first pixel electrode 61 overlapping the scan line 522 and the first storage capacitor electrode line 561 (including the extension line 5611) forms a storage capacitor for storing the data signal. Thus, the first pixel electrode 61 can still maintain the voltage for fixing the data signal until the first pixel electrode 61 begins to be charged at the next scan. The second pixel electrode 62 overlapping the scan line 521 and the second storage capacitor electrode line 562 (including the extension line 5622) forms a storage capacitor for storing the data signal. Thus, the second pixel electrode 62 can still maintain the voltage for fixing the data signal until the second pixel electrode 62 begins to be charged at the next scan. The third pixel electrode 63 overlapping the scan line 524 and the first storage capacitor electrode line 561 (including the extension line 5613) forms a storage capacitor for storing the data signal. Thus, the third pixel electrode 63 can still maintain voltage for fixing the data signal until the third pixel electrode 63 begins to be charged at the next scan. The fourth pixel electrode 64 overlapping the scan line 523 and the second storage capacitor electrode line 562 (including the extension line 5624) forms a storage capacitor for storing the data signal. Thus, the fourth pixel electrode 64 can still maintain the voltage for fixing the data signal until the fourth pixel electrode 64 begins to be charged at the next scan.

The storage capacitor electrode lines 561 and 562 and the scan lines 521-524 neither use the same metal layer nor appear on the same plane. So no capacitive coupling effect will occur no matter how close the scan lines 521-524 and the storage capacitor electrode lines 561-562 are. Owing to almost no capacitive coupling effect occurs between the scan lines 521-524 and the storage capacitor electrode lines 561-562, it is allowed for a gap d3 between the storage capacitor electrode lines 561-562 and the scan lines 521-524 (e.g., between the third storage capacitor electrode extension line 5613 and the third scan line 523) to be smaller (compared with the conventional gap d1), or even to be zero. So the area of each of the pixel electrodes 61-64 can be larger, i.e., a larger aperture ratio. Moreover, the storage capacitor is fabricated as a storage capacitor-on-gate (Cs-on-gate) design so that the aperture ratio can further be increased. And the metal layer which forms the storage capacitor electrode extension lines 5611, 5613, 5622, and 5624 blocks light so that a black matrix layer is designed to shrink toward the scan lines 521-524, causing the aperture ratio to be further increased. Therefore, the cost of the TFT array panel 300 can be reduced more, and the display performance of the TFT array panel 300 can be enhanced.

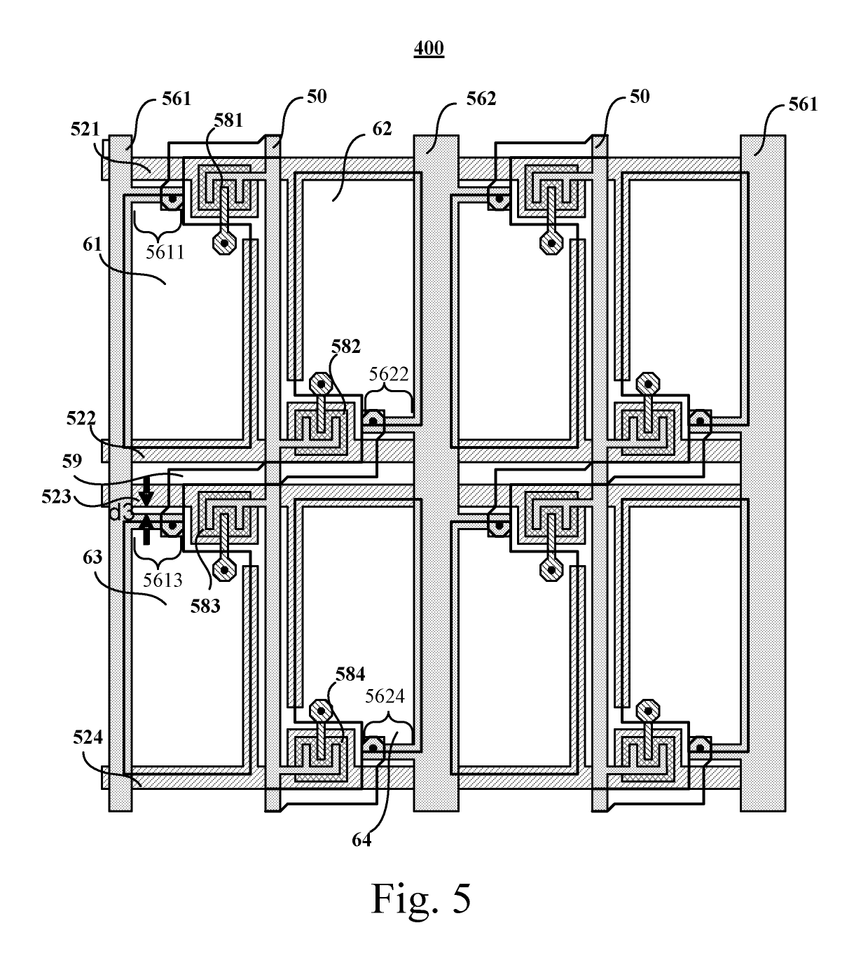

Refer to FIG. 5, which shows a layout of a TFT array panel 400 according to a fourth embodiment of the present invention. Differing from the TFT array panel 300, the TFT array panel 400 has a connection line 59 connected between the third storage capacitor electrode extension line 5613 and the second storage capacitor electrode extension line 5622. Owing to the connection line 59, the storage capacitor electrode lines 561 and 562 are less influenced by capacitive coupling effects caused by other signals, which solves a crosstalk problem and further improves display quality of the TFT array panel 400.

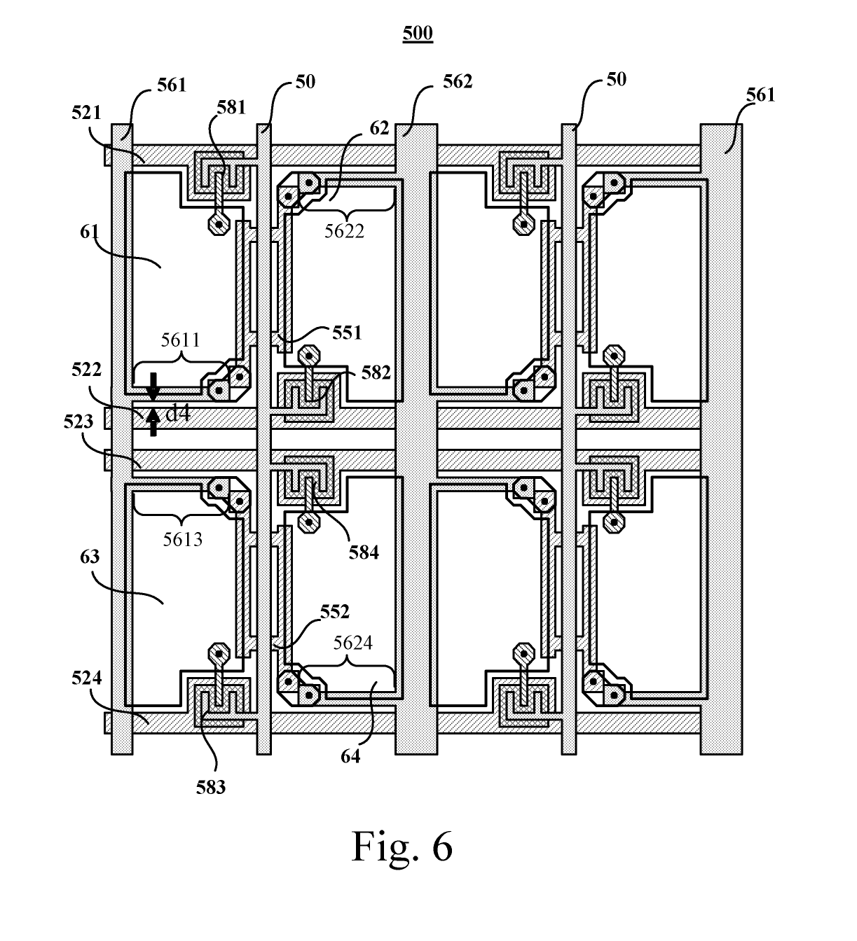

Please refer to FIG. 6 showing a layout of a TFT array panel 500 according to a fifth embodiment of the present invention. The first electrode 61 is electrically connected to the first scan line 521 and the data line 50 via a transistor 581. The second electrode 62 is electrically connected to the second scan line 522 and the data line 50 via a transistor 582. The third electrode 63 is electrically connected to the fourth scan line 524 and the data line 50 via a transistor 583. The fourth electrode 64 is electrically connected to the third scan line 523 and the data line 50 via a transistor 584. The first storage capacitor electrode line 561, the second storage capacitor electrode line 562, and the data line 50 all made of the same material are disposed on the same plane. The first storage capacitor electrode line 561 and the second storage capacitor electrode line 562 are alternatively arranged with the data line 50.

A first storage capacitor electrode line 561 further comprises a first storage capacitor electrode extension line 5611 extended toward the data line 50 from the first storage capacitor electrode line 561. The second storage capacitor electrode line 562 further comprises a second storage capacitor electrode extension line 5622 extended toward the data line 50 from the second storage capacitor electrode line 562. The first storage capacitor electrode line 561 further comprises a third storage capacitor electrode extension line 5613 extended toward the data line 50 from the first storage capacitor electrode line 561. The second storage capacitor electrode line 562 further comprises a fourth storage capacitor electrode extension line 5624 extended toward the data line 50 from the second storage capacitor electrode line 562. According to the present embodiment, the extension line 5611 is close to and parallel to the second scan line 522. The extension line 5622 is close to and parallel to the first scan line 521. The extension line 5613 is close to and parallel to the third scan line 523. The extension line 5624 is close to and parallel to the fourth scan line 524. A connection region 551 and the scan lines 521-522 are made of the same material and on the same plane. The connection region 551 is electrically connected to the first storage capacitor electrode extension line 5611 and the second storage capacitor electrode extension line 5622. A connection region 552 is electrically connected between the third storage capacitor electrode extension line 5613 and the fourth storage capacitor electrode extension line 5624. The connection region 552 and the scan lines 523-524 are made of the same material and on the same plane.

To let the first pixel electrode 61 display gray levels based upon the data signal even though the scan signal does not drive the transistor 581, the first pixel electrode 61 overlapping the connection region 551 and the first storage capacitor electrode line 561 (including the extension line 5611) forms a storage capacitor for storing the data signal. Thus, the first pixel electrode 61 can still maintain the voltage for fixing the data signal until the first pixel electrode 61 begins to be charged at the next scan. The second pixel electrode 62 overlapping the connection region 551 and the second storage capacitor electrode line 562 (including the extension line 5622) forms a storage capacitor for storing the data signal. Thus, the second pixel electrode 62 can still maintain the voltage for fixing the data signal until the second pixel electrode 62 begins to be charged at the next scan. The third pixel electrode 63 overlapping the connection region 552 and the first storage capacitor electrode line 561 (including the extension line 5613) forms a storage capacitor for storing the data signal. Thus, the third pixel electrode 63 can still maintain voltage for fixing the data signal until the third pixel electrode 63 begins to be charged at the next scan. The fourth pixel electrode 64 overlapping the connection region 552 and the second storage capacitor electrode line 562 (including the extension line 5624) forms a storage capacitor for storing the data signal. Thus, the fourth pixel electrode 64 can still maintain the voltage for fixing the data signal until the fourth pixel electrode 64 begins to be charged at the next scan.

The storage capacitor electrode lines 561 and 562 and the scan lines 521-524 neither use the same metal layer nor appear on the same plane. So no capacitive coupling effect will occur no matter how close the scan lines 521-524 and the storage capacitor electrode lines 561-562 are. Owing to almost no capacitive coupling effect occurs between the scan lines 521-524 and the storage capacitor electrode lines 561-562, it is allowed for a gap d4 between the storage capacitor electrode lines 561-562 and the scan lines 521-524 (e.g., between the third storage capacitor electrode extension line 5613 and the third scan line 523) to be smaller (compared with the conventional gap d1), or even to be zero. So the area of each of the pixel electrodes 61-64 can be larger, i.e., a larger aperture ratio. Therefore, the cost of the TFT array panel 500 can be reduced more, and the display performance of the TFT array panel 500 can be enhanced.

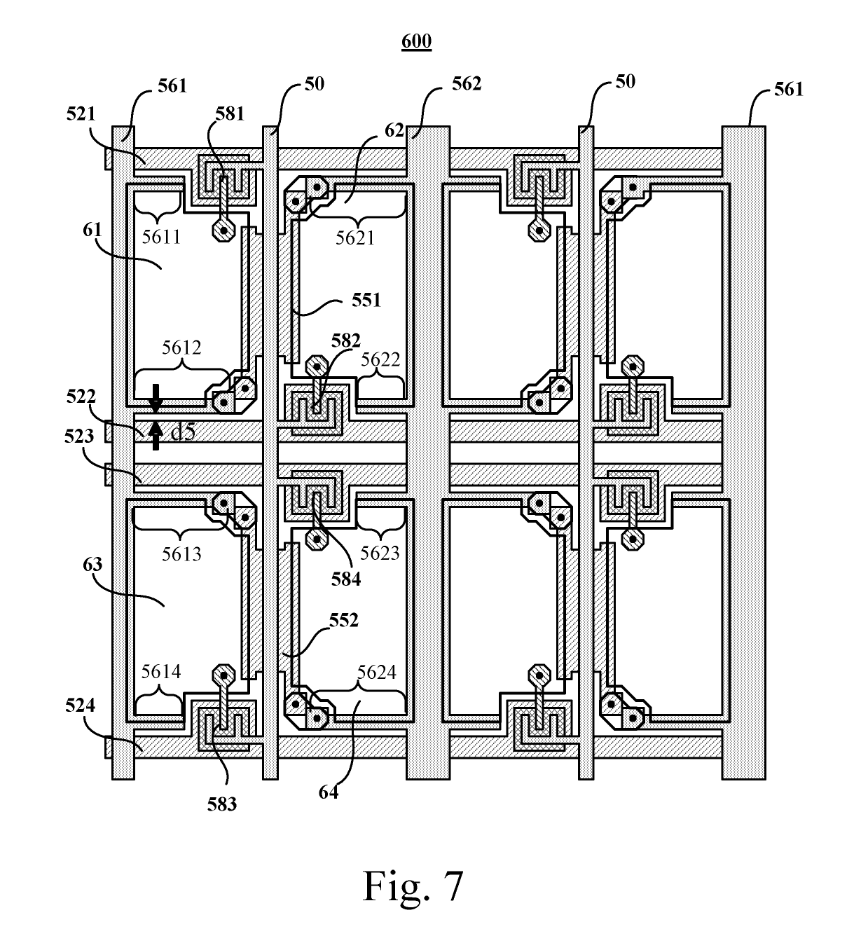

Please refer to FIG. 7 showing a layout of a TFT array panel 600 according to a sixth embodiment of the present invention. A first storage capacitor electrode line 561 of the TFT array panel 600 comprises storage capacitor electrode extension lines 5611, 5612, 5613, and 5614 extended toward the data line 50 from the first storage capacitor electrode line 561. A second storage capacitor electrode line 562 comprises storage capacitor electrode extension lines 5621, 5622, 5623, and 5624 extended toward the data line 50 from the second storage capacitor electrode line 562. According to the present embodiment, the extension lines 5611, 5612, 5613, and 5614 are close to and parallel to the scan lines 521, 522, 523, and 524, respectively. The extension lines 5621, 5622, 5623, and 5624 are close to and parallel to the scan lines 521, 522, 523, and 524.

To let the first pixel electrode 61 display gray levels based upon the data signal even though the scan signal does not drive the transistor 581, the first pixel electrode 61 overlapping the connection region 551 and the first storage capacitor electrode line 561 (including the extension lines 5611 and 5612) forms a storage capacitor for storing the data signal. Thus, the first pixel electrode 61 can still maintain the voltage for fixing the data signal until the first pixel electrode 61 begins to be charged at the next scan. The second pixel electrode 62 overlapping the connection region 551 and the second storage capacitor electrode line 562 (including the extension lines 5621 and 5622) forms a storage capacitor for storing the data signal. Thus, the second pixel electrode 62 can still maintain the voltage for fixing the data signal until the second pixel electrode 62 begins to be charged at the next scan. The third pixel electrode 63 overlapping the connection region 552 and the first storage capacitor electrode line 561 (including the extension lines 5613 and 5614) forms a storage capacitor for storing the data signal. Thus, the third pixel electrode 63 can still maintain the voltage for fixing the data signal until the third pixel electrode 63 begins to be charged at the next scan. The fourth pixel electrode 64 overlapping the connection region 552 and the second storage capacitor electrode line 562 (including the extension lines 5623 and 5624) forms a storage capacitor for storing the data signal. Thus, the fourth pixel electrode 64 can still maintain the voltage for fixing the data signal until the fourth pixel electrode 64 begins to be charged at the next scan.

The storage capacitor electrode lines 561 and 562 and the scan lines 521-524 neither use the same metal layer nor appear on the same plane. So no capacitive coupling effect will occur no matter how close the scan lines 521-524 and the storage capacitor electrode lines 561-562 are. Owing to almost no capacitive coupling effect occurs between the scan lines 521-524 and the storage capacitor electrode lines 561-562, it is allowed for a gap d5 between the storage capacitor electrode lines 561-562 and the scan lines 521-524 (e.g., between the storage capacitor electrode extension line 5612 and the scan line 522) to be smaller (compared with the conventional gap d1), or even to be zero. So the area of each of the pixel electrodes 61-64 can be larger, i.e., a larger aperture ratio. Moreover, the storage capacitor is fabricated as a storage capacitor-on-gate (Cs-on-gate) design so that the aperture ratio can further be increased. And the metal layer which forms the storage capacitor electrode extension lines 5611, 5614, 5622, and 5623 blocks light so that a black matrix layer is designed to shrink toward the scan lines 521-524, causing the aperture ratio to be further increased. Therefore, the cost of the TFT array panel 600 can be reduced more, and the display performance of the TFT array panel 600 can be enhanced.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A liquid crystal display (LCD), comprising:
a first pixel electrode and a second pixel electrode;
a first scan line and a second scan line, the first scan line being electrically connected to the first pixel electrode, and the second scan line being electrically connected to the second pixel electrode;
a data line electrically connected to the first pixel electrode and the second pixel electrode; and
a first storage capacitor electrode line and a second storage capacitor electrode line, formed at both sides of the data line and crossing over the first scan line and the second scan line, wherein the first storage capacitor electrode line further comprises a first storage capacitor electrode extension line extending toward the data line from the first storage capacitor electrode line, and the second storage capacitor electrode line further comprises a second storage capacitor electrode extension line extending toward the data line from the second storage capacitor electrode line, and an edge of the first pixel electrode partially overlaps with the first storage capacitor electrode line and with the first storage capacitor electrode extension line, and an edge of the second pixel electrode partially overlaps with the second storage capacitor electrode line and with the second storage capacitor electrode extension line.

2. The LCD of claim 1, wherein the first storage capacitor electrode line, the second storage capacitor electrode line, the first storage capacitor electrode extension line, the second storage capacitor electrode extension line, and the data line are made of the same material.

3. The LCD of claim 1 further comprising a connection region electrically connected to the first storage capacitor electrode extension line and to the second storage capacitor electrode extension line.

4. The LCD of claim 1, further comprising:
a third pixel electrode and a fourth pixel electrode, the third pixel electrode being electrically connected to the data line and to the first storage capacitor electrode line, and the fourth pixel electrode being electrically connected to the data line and to the second storage capacitor electrode line, and the third pixel electrode partially overlapping with the first storage capacitor electrode line, and the fourth pixel electrode partially overlapping with the second storage capacitor electrode line; and
a third scan line electrically connected to the third pixel electrode and a fourth scan line electrically connected to the fourth pixel electrode.

5. The LCD of claim 4, wherein the first storage capacitor electrode line further comprises a third storage capacitor electrode extension line extending toward the data line from the first storage capacitor electrode line, and the second storage capacitor electrode line further comprises a fourth storage capacitor electrode extension line extending toward the data line from the second storage capacitor electrode line.

6. The LCD of claim 5, wherein the first storage capacitor electrode extension line is close to and parallel to the second scan line, the second storage capacitor electrode extension line is close to and parallel to the first scan line, the third storage capacitor electrode extension line is close to and parallel to the fourth scan line, and the fourth storage capacitor electrode extension line is close to and parallel to the third scan line.

7. The LCD of claim 6, further comprising a connection line electrically connected to the first storage capacitor electrode extension line and to the fourth storage capacitor extension line electrode.

8. The LCD of claim 5, wherein the first storage capacitor electrode extension line is close to and parallel to the first scan line, the second storage capacitor electrode extension line is close to and parallel to the second scan line, the third storage capacitor electrode extension line is close to and parallel to the third scan line, and the fourth storage capacitor electrode extension line is close to and parallel to the fourth scan line.

9. The LCD of claim 8, further comprising a connection line electrically connected to the second storage capacitor electrode extension line and to the third storage capacitor electrode extension line.
